(19) United States
(12) Patent Application Publication
(10) Pub. No.: US 2006/0017790 A1
(43) Pub. Date: Jan. 26, 2006

(54) Seal ring and ink cartridge using thereof

(75) Inventor: Benyou Jin, Guandong (CN)

Correspondence Address: VENABLE LLP, P.O. BOX 34385, WASHINGTON, DC, 20045-9998, US

(73) Assignee: Print-Rite-Unicorn Image Products Co., Ltd. of Zhuhai, Zhuhai, Guangdong (CN)

(21) Appl. No.: 10/533,074

(22) PCT Filed: Dec. 19, 2003
(86) PCT No.: PCT/CN03/01096

§ 371 Date: Apr. 28, 2005

(30) Foreign Application Priority Data
Jan. 14, 2003 (CN) 03201870.3

(51) Int. Cl. B41J 2/175

(52) U.S. Cl. 347/86

(57) ABSTRACT

The invention involves seal rings useful for ink cartridges. The invention also involves ink cartridges having such seal rings. The seal ring comprises a tube-shaped, elastic part having an insertion opening at its lower end for receiving an ink supply needle. The top of the insertion opening includes a top sealing film. The top sealing film closes in its natural state and prevents ink from leaking through. The seal ring of the invention is simple in structure and effective in preventing ink from leaking out.

### CROSS-REFERENCE TO RELATED APPLICATION

This application claims the priority of Chinese Patent Application No. 03201870.3, filed on Jan. 14, 2003, the subject matter of which is incorporated herein by reference.

### FIELD OF THE INVENTION

The invention relates to seal rings used for an ink jet recording device and to ink jet recording devices having such seal rings.

### BACKGROUND OF THE INVENTION

Ink jet recording equipment, for example, ink jet printers, often use replaceable ink supply devices such as ink cartridges. There are many methods to supply ink to ink jet recording equipment. In one method, the recording device is equipped with an ink supply needle that has an ink passageway. Upon insertion into the ink outlet of the ink supply device, the ink supply needle passes the ink from the ink supply device to the printing head of the recording device. To allow the ink to flow only through the ink passageway, the outlet of the ink supply device is equipped with a seal ring. Often there is an aperture on the seal ring surrounding the needle to prevent the ink from flowing out through the gap between the needle and the seal ring. One disadvantage of this method is that when an unexhausted ink cartridge is removed from the recording device, the ink leaks through the aperture. Often an ink indicator shows the ink is exhausted although it is not. The ink leakage contaminates the surroundings and dirties the clothes of workers. Placing the unexhausted ink supply device back on the recording device also causes poor printing results.

There is a known technology which overcomes the above problem. The technology is shown in FIG. 14. To illustrate, FIG. 14 only shows an outlet part of an ink cartridge. According to FIG. 14, a valve 16 is equipped inside a seal ring 18 of the ink outlet; the valve 16 consists of a valve rod and a valve surface. A spring 17 is equipped between the top of the ink outlet and the valve surface. Under the force of spring 17, the valve surface tightly seals the top opening of the seal ring 18. The ink outlet of a new ink cartridge is often sealed with a film 20. FIG. 15 shows the ink cartridge placed on a recording device. The ink supply needle 19 punches through the film 20, passes through the opening of the seal ring 18, opens the valve surface, and enters the ink chamber, thus allowing the ink from the ink chamber to flow through the passageway of the ink supply needle 19. The top opening of the seal ring 18 tightly surrounds the needle, preventing the ink from leaking out. When the ink cartridge is removed from the recording device, the ink supply needle 19 is withdrawn and the valve 16, under the force of the spring 17, resumes sealing the opening of the seal ring 18, preventing remaining ink from leaking out.

The above technology avoids ink outflow when the ink cartridge is removed. However, it has a complex structure that is difficult and costly to make. Furthermore, the valve is made from rigid material. This may cause the ink supply needle, which repeatedly presses the valve during replacement of the ink cartridges, to wear and tear fast.

Additionally, because the ink supply needle is in a cantilever state, it cannot be firmly fixed, and thus it may become crooked after extensive use.

### BRIEF SUMMARY OF THE INVENTION

An object of the invention is to provide a seal ring which has the valve function, but which avoids the aforementioned disadvantages.

Another object of the invention is to provide a seal ring which can stabilize the ink supply needle when the needle punches through the seal ring.

An additional object of the invention is to provide an ink cartridge having such seal ring.

To realize the above objects, the seal ring of the invention comprises a tube-shaped, elastic part. The low end of the elastic part has an upwardly-extending insertion opening for receiving an ink supply needle. The insertion opening is not completely open in its natural state. Instead, the top of the opening is sealed with a film of certain thickness. The center of the sealing film has a crack which connects an inner part of the opening with a space above the sealing film. The crack is closed when it is under no strain and thus prevents ink from leaking through. It allows the ink supply needle to pass through and tightly seals around the ink supply needle to prevent the ink from leaking.

To stabilize the ink supply needle, the insertion opening can have a narrower portion with a circular cross-section. The diameter of the narrower portion is smaller than that of the ink supply needle. Thus, when the ink supply needle passes through the narrower portion, the narrower portion firmly holds the needle, preventing the needle from becoming crooked.

In practice, the narrower portion is axially raised from the bottom of the elastic part.

In a recording device which is not often used, the ink supply needle may be inserted in the seal ring for more than a half year. This may cause the crack to permanently deform. After the ink supply needle is withdrawn, the crack is thus no longer able to close, resulting in ink leaking. Thus, the top of the seal ring is provided with a symmetrical support, one end of which is located on an inside wall of the seal ring and another end is located around the top sealing film. When the ink supply needle is withdrawn, the support pushes the crack closed. Theoretically, the support increases the wall thickness around the crack and thus prevents its permanent deformation. In one embodiment, the surface of the top sealing film overlaps with the surface of the symmetric support. Thus, the recovering force of the support not only enables the crack to hold the ink supply needle tightly but also causes the crack to close when the ink supply needle is withdrawn. Otherwise, the crack is subject to permanent deformation and lacks the ability to close.

The ink cartridge of the invention comprises an ink outlet that supplies ink from an ink chamber. A seal ring is positioned inside the ink outlet. The seal ring is a tube-shaped, elastic part. An outer wall of the seal ring connects with an inner wall of the ink outlet and seals it. At a lower end of the seal ring is an insertion opening for an ink supply needle. The top of the insertion opening is provided with a sealing film. The center of the sealing film has a crack which connects an inner space of the insertion opening and an upper space above the sealing film.

### BRIEF DESCRIPTION OF THE SEVERAL VIEWS OF THE DRAWINGS

FIG. 1 is a three-dimensional view of a first embodiment of the seal ring of the invention.

FIG. 2 is a sectional view of FIG. 1.

FIG. 3 is a three-dimensional view of a second embodiment of the seal ring of the invention.

FIG. 4 is a sectional view of FIG. 3.

FIG. 5 is a three-dimensional view of a third embodiment of the seal ring of the invention.

FIG. 6 is a sectional view of FIG. 5.

FIG. 7 is a three-dimensional view of a fourth embodiment of the seal ring of the invention.

FIG. 8 is a sectional view of FIG. 7.

FIG. 9 is a three-dimensional view of a fifth embodiment of the seal ring of the invention.

FIG. 10 is a sectional view of FIG. 9.

FIG. 11 is a sectional view of FIG. 9 from a different direction.

FIG. 12 is a perspective, structural view of the ink cartridge of the invention which is placed onto a recoding device.

FIG. 13 is a perspective, structural view of the ink cartridge before placed onto a recording device.

FIG. 14 is a perspective, structural view of a known ink cartridge before placed onto recording device.

FIG. 15 is a perspective, structural view of the known ink cartridge which is placed onto a recording device.

### DETAILED DESCRIPTION OF THE INVENTION

The following embodiments illustrate the invention and further describe the above drawings.

### Embodiment 1

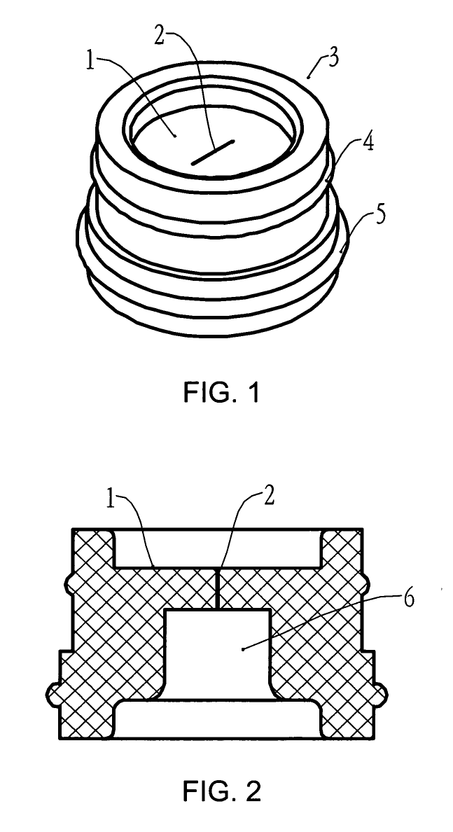

As shown in FIG. 1, the seal ring is a tube-shaped, elastic part. On an outer wall, there are raised ring structures 4 and 5 which are used to connect with and seal the inner wall of an ink cartridge outlet. On the top of the seal ring, there is a sealing film 1, which includes a crack 2 therein.

FIG. 2 is a sectional view of the seal ring along the vertical direction of the crack 2. As shown in FIG. 2, there is an insertion opening 6 which extends upwardly. The internal diameter of the insertion opening 6 is approximately the same as an external diameter of an ink supply needle. The top sealing film 1 is located on the top of the insertion opening 6. In its natural state, the top of the insertion opening 6 is closed. When the crack 2 opens, the insertion opening 6 connects to a space above the top sealing film 1. The top sealing film 1 has certain thickness that enables the crack 2 to close naturally. The maximum diameter of the space above the top sealing film 1, where the crack 2 is located, is smaller than a diameter of the insertion opening 6. When the ink supply needle passes through the crack 2, the top sealing film 1 elastically deforms to form a cylinder which tightly seals around the ink supply needle.

### Embodiment 2

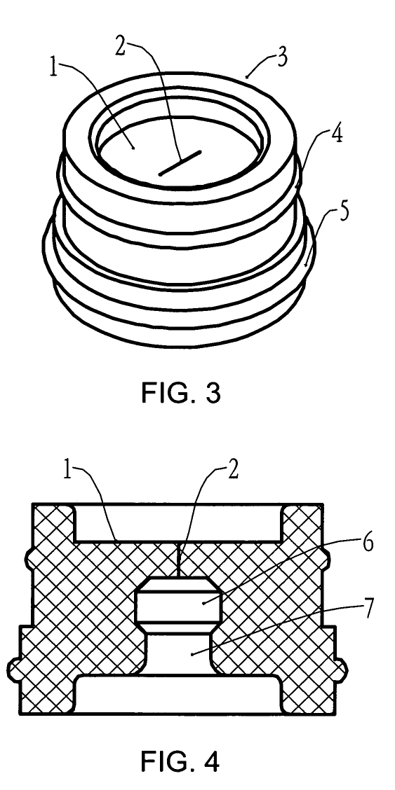

As shown in FIG. 3, the seal ring of this embodiment looks, from its outside, the same as that of Embodiment 1. The same part numbers in this embodiment denote the same as the previous.

FIG. 4 is a sectional view of the seal ring along the vertical direction of the crack 2. An insertion opening 6 extends upwardly. In this embodiment, however, the bottom of the insertion opening 6 includes a narrower portion 7. The internal diameter of the insertion opening 6 is approximately the same as the external diameter of ink supply needle, while the internal diameter of the narrower portion 7 is smaller than the external diameter of the ink supply needle. The narrower portion 7 stabilizes and further seals the ink supply needle. Atop sealing film 1 is located on the top of the insertion opening 6. In its natural state, the insertion opening 6 is closed. When the crack 2 opens upon insertion of the ink supply needle, the insertion opening 6 connects to the space above the top sealing film 1. The top sealing film 1 has certain thickness to enable the crack 2 to close naturally. The maximum diameter of the space above the top sealing film 1, where the crack 2 is located, is smaller than a diameter of the insertion opening 6. When the ink supply needle passes through the crack 2, the top sealing film 1 elastically deforms to form a cylinder which tightly seals around the ink supply needle.

### Embodiment 3

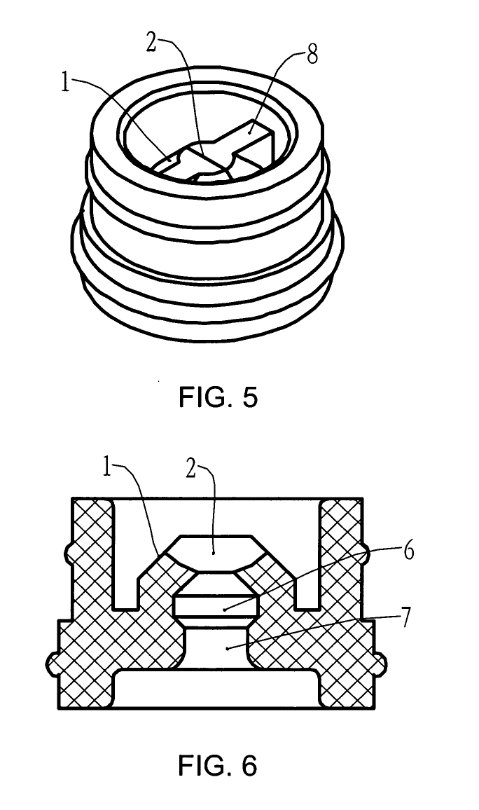

As shown in FIG. 5, the seal ring of this embodiment is provided with a support 8 which meets the crack 2 at right angles.

FIG. 6 is a sectional view of the seal ring along the vertical direction of the crack 2. The top sealing film 1 is approximately semi-spherical in shape. The length of the crack 2 is the same as or slightly smaller than the diameter of the insertion opening 6, i.e., the same as or slightly smaller than the diameter of the ink supply needle. As shown in FIG. 6, the diameter of the narrower portion 7 is smaller than that of the ink supply needle.

### Embodiment 4

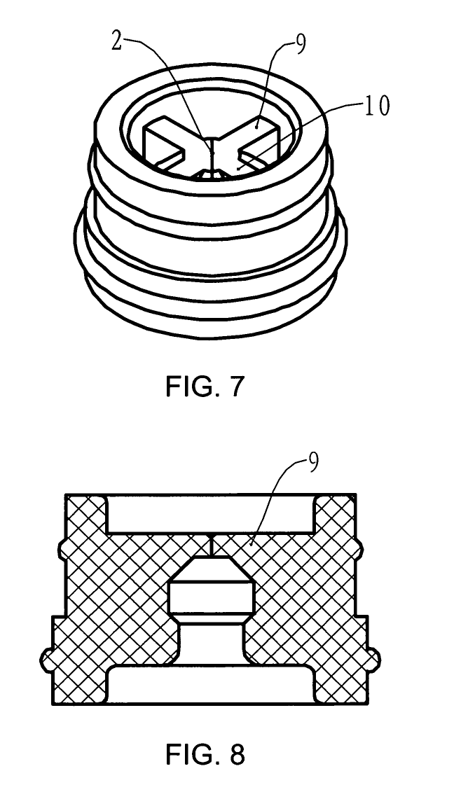

As shown in FIG. 7 and FIG. 8, the seal ring of this embodiment is essentially the same as Embodiment 3. It differs from Embodiment 3 in that it has two supports 9 and 10 which cross each other to support the crack 2. FIG. 8 is a sectional view of the seal ring along the center of support 9.

### Embodiment 5

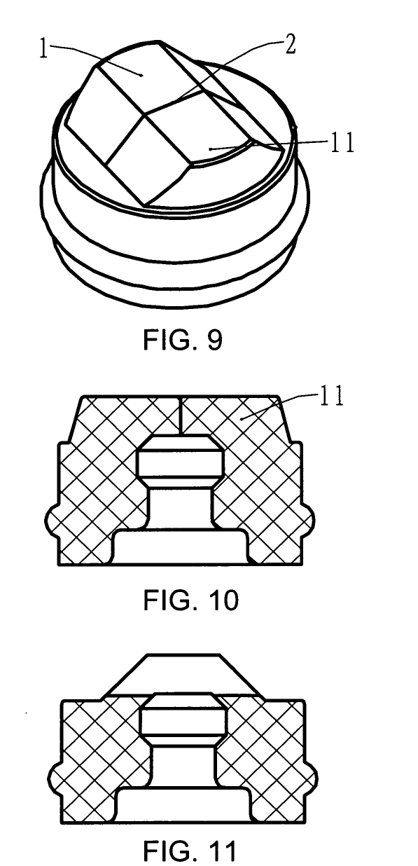

For small ink cartridges, the ink outlets have small inner diameters. Therefore, the seal rings for small ink cartridges require small external diameters. For such small seal rings, the top sealing film 1 can be designed as shown in FIGS. 9, 10, and 11. The top sealing film 1 can be relatively thick and may include additional supports 11 to better stabilize the ink supply needle.

### Embodiment 6

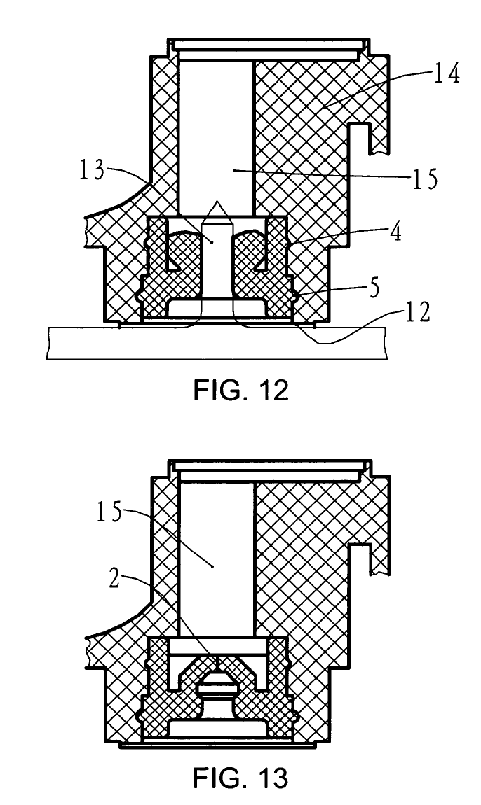

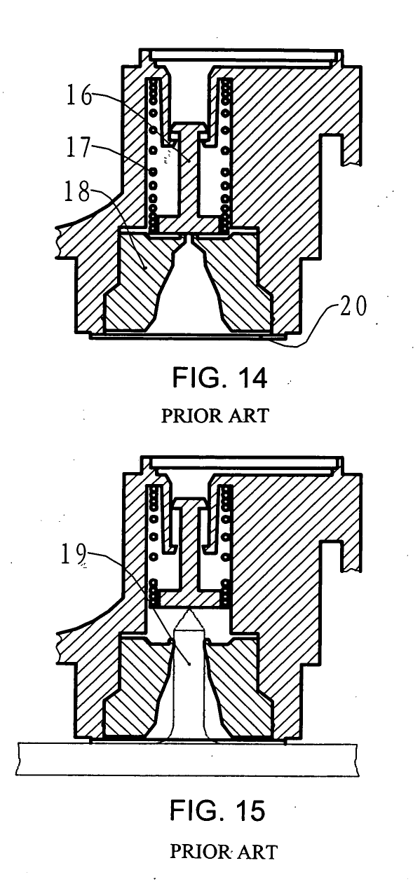

FIGS. 12 and 13 give an example of ink cartridge 14 equipped with a seal ring. To make it simple, the figures only show the structure around the ink outlet. The external wall of the seal ring elastically presses on the ink outlet of the ink cartridge 14. The raised rings 4 and 5 increase the sealing. When the ink cartridge 14 is placed on a printer, the ink supply needle 13 breaks the sealing film 12, enters the insertion opening 6, passes through the crack 2, and extends into the ink chamber 15. An ink passageway is formed. When the ink cartridge 14 is removed from the printer, the ink supply needle 13 withdraws in an opposite order. The crack 2 closes due to its elastic recovery and the push from the support, and thus the ink outflow from the ink chamber 15 stops.

The seal ring of the invention is made from an elastic material. It differs from those known in that it is provided with a top sealing film 1. The size of the top sealing film 1 varies according to the ink supply needle 13 of the recording device, elasticity of the material, and many other factors. The ink cartridges 14 of the invention, due to the use of the seal ring, not only work better, but also have much simpler structures compared to known products. It not only resolves the ink leakage problem that occurs when the ink cartridge 14 is placed on or taken away from a printer, but also provides better protection to the ink supply needle 13. Accordingly, it reduces the manufacture cost.

The invention has been described in detail with respect to various embodiments, and it will now be apparent from the foregoing to those skilled in the art, that changes and modifications may be made without departing from the invention in its broader aspects, and the invention, therefore, as defined in the appended claims, is intended to cover all such changes and modifications that fall within the true spirit of the invention.

1. A seal ring comprising a tube-shaped, elastic part having an insertion opening at a lower end for receiving an ink supply needle, wherein the top of the insertion opening includes a top sealing film having a crack connecting the insertion opening and a space above the top sealing film.

2. The seal ring of claim 1, wherein the insertion opening has a narrower portion having a diameter smaller than that of the ink supply needle.

3. The seal ring of claim 2, wherein the narrower portion is formed by rings which are axially raised from the lower end of the tube-shaped, elastic part.

4. The seal ring of claim 1, wherein the top of the tube-shaped, elastic part is provided with a symmetric support, one end of the support being located on an internal wall of the tube-shaped, elastic part, and another end of the support being located around the top sealing film.

5. The sealing of claim 4, wherein a surface on which the crack is located overlaps with a surface of the symmetric support.

6. An ink cartridge comprising an ink outlet which supplies ink from an internal ink chamber, wherein the ink outlet is provided with a seal ring, the seal ring comprises a tube-shaped, elastic part, an external wall of the elastic part tightly connecting with an internal wall of the ink outlet, and a lower end of the elastic part including an insertion opening for receiving an ink supply needle; wherein the top of the insertion opening includes a top sealing film having a crack connecting the insertion opening and a space above the top sealing film.

7. The ink cartridge of claim 6, wherein the insertion opening has a narrower portion having a diameter smaller than that of the ink supply needle.

8. The ink cartridge of claim 7, wherein the narrower portion is formed by rings which are axially raised from the lower end of the tube-shaped, elastic part.

9. The ink cartridge of claim 6, wherein the top of the tube-shaped, elastic part includes a symmetric support, one end of the support being located on an internal wall of the tube-shaped, elastic part, and another end of the support being located around the top sealing film.

10. The ink cartridge of claim 9, wherein a surface on which the crack is located overlaps with a surface of the symmetric support.
